(19) United States
(12) Patent Application Publication
(10) Pub. No.: US 2006/0248189 A1
(43) Pub. Date: Nov. 2, 2006

(54) Reverse proxy system and method

(75) Inventors: Stanley K. Jerrard-Dunne, Dublin (IE); Bill Looby, Dublin (IE)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/221,443

(22) Filed: Sep. 8, 2005

(30) Foreign Application Priority Data
Apr. 28, 2005 (GB) 0508624.4

(51) Int. Cl. G06F 15/173

(52) U.S. Cl. 709/225

(57) ABSTRACT

A reverse proxy system and method employs rule tailoring through usage tracking having configuration rules track their own individual usage, by determining if they were required during processing of content, over a particular time, and autonomically (or interactively) removing themselves from the processing rules list as determined. This provides the advantage of adding automatic or selective performance configuration to the rule based reverse-proxying concept, without requiring any knowledge of rule writing.

### BACKGROUND OF THE INVENTION

1. Field of the Invention

This invention relates to data processing, and in particular to a reverse proxy system and method.

2. Related Art

The World Wide Web is the Internet's multimedia information retrieval system. In the web environment, client machines communicate with web servers using the HyperText Transfer Protocol (HTTP). The web servers provide users with access to files such as text, graphics, images, sound, video, etc., using a standard page description language known as HyperText Markup Language (HTML). HTML provides basic document formatting and allows the developer to specify connections known as hyperlinks to other servers and files. In the Internet paradigm, a network path to a server is identified by a resource address called a Uniform Resource Locator (URL) having a special syntax for defining a network connection. So-called Web browsers, for example, Netscape Navigators™ (Netscape Navigator is a registered trademark of Netscape Communications Corporation) or Microsoft™ Internet Explorers™ (Microsoft and Internet Explorer are trademarks of Microsoft Corporation), which are application programs running on client computer systems, enable users to access information by specification of a link via the URL and to navigate between different HTML pages.

When the user of the web browser selects a link, the client machine issues a request to a naming service to map a hostname (in the URL) to a particular network IP (Internet Protocol) address at which the server machine is located. The naming service returns an IP address that can respond to the request. Using the IP address, the web browser establishes a connection to the server machine. If the server machine is available, it returns a web page. To facilitate further navigation within the site, a web page typically includes one or more hypertext references (HREFs) known as “anchors” or “links.”

A “portal” is a web application which arranges web content into a portal page containing one or more “portlets.” A portlet is a web component, managed by a portlet software container, which processes and generates dynamic web content. This content, often called a fragment, can be aggregated by the portal with content from other portlets to form the portal page. The content generated by a portlet may vary from one user to another depending on the user configuration for the portlet. A portal can act as a gateway to one or more backend software applications and can be provided on a separate portal server. The portal can be used to deliver customized application content, such as forums, search engines, email and other information, within a standard template and using a common user interface mechanism. Users can be offered a single, personalized view of all the backend applications with which they work and can obtain access to a plurality of those backend applications through a single security sign-on.

Web clients interact with portlets via a request/response paradigm implemented by the portal. Normally, users interact with content produced by portlets, for example by submitting forms or following links, resulting in portlet action requests being received by the portal which are forwarded by it to the portlets targeted by the user's interactions.

A portal server used to provide a client with access to backend applications is disclosed in United States Patent Application Publication 2003/0167298, which is incorporated herein by reference. The portal server is positioned in a Demilitarized Zone (DMZ), between a pair of firewalls and implements authentication of the client and checking of access privileges of the client. If the client is authorized, it will be allowed to access the backend applications.

For further improved security, reverse proxy (also called IP-forwarding) topologies may be used. These use a reverse proxy server to represent a secure content server to outside clients. Outside clients are not allowed to access the content server; their requests are sent to the reverse proxy server instead, which then forwards the client requests to the content server. The content server, which may be a portal server, forwards the requests to the applications or application servers for processing. The reverse proxy server returns the completed request to the client while hiding the identity of the portal and application servers from the client. This prevents the outside clients from obtaining direct, unmonitored access to the real content server.

Reverse proxy servers require significant configuration in order to correctly serve applications. Moreover, the reverse proxy server might be used only for applications that have been developed with reverse proxying in mind, for example only for applications in which all links to files on a web or portal server do not refer to the full host name. Further, using a reverse proxy server, it is not possible to change the configuration rules for a particular application—there is just one set of rules for all applications being reverse proxied by that server. Thus, by changing the rules for one application, the rules are changed for all applications. Additionally, reverse proxy servers cannot cope with the dynamic creation of Hypertext References (HREFs), for example by JavaScript™ (JavaScript is a registered trademark of Sun Microsystems, Inc.) or the parameterization of applets.

Reverse proxying is an ideal method of integrating web Sites into portals and is implemented by a number of portlets, for example IBM™'s Domino Application Portlet being the portlet used where Domino Web Application integration is required. However a “complete” set of rules is time consuming to apply to every request.

From United States Patent Application Publications US2003/0115281A, US2003/0115346A and US2003/0115421A, there are known mechanisms whereby the rules that are actually used are tracked, so that other rules can be removed. However, in these patent publications the rules are essentially used to select only content for caching (for forward and reverse proxying), resulting in their reverse-proxying being a Quality of Service (with respect to response times) determinant. Also, their caching is client-side based (from an internet perspective), making it only applicable to fully managed networks.

Further, although these patent publications refer to multiple rules bases being generated by a content director potentially based on information autonomously generated by the content director, the exact nature of this autonomy is not described. Also, although these patent publications refer to rule bases being distributed by the content director to agent applications for local autonomous implementation, such autonomy simply means that the agent can act independently of the content director.

A need therefore exists for reverse proxying wherein the abovementioned disadvantage(s) may be alleviated.

### SUMMARY OF INVENTION

In accordance with a first aspect of the present invention there is provided reverse proxy system for proxying, on a portal server, one or more web applications running on a web server, in response to a request for web content from a client computer system, the reverse proxy system comprising: a portlet; a set of configuration rules; a rewriting mechanism configured to: forward data, relating to a client request for web content, to a web application on the web server; receive a response from the web application; and rewrite the received response in accordance with the configuration rules; tracking means for tracking usage of the set of configuration rules; and tailoring means, dependent on the tracking means, for tailoring at least one of the configuration rules for further processing.

In accordance with a second aspect of the present invention there is provided a reverse proxy method for proxying, on a portal server, one or more web applications running on a web server, in response to a request for web content from a client computer system, the reverse proxy method comprising: providing a portlet; providing a set of configuration rules; in a rewriting mechanism: forwarding data, relating to a client request for web content, to a web application on the web server; receiving a response from the web application; and rewriting the received response in accordance with the configuration rules; tracking usage of the set of configuration rules; and tailoring, dependent on the tracked usage, at least one of the configuration rules for further processing.

Briefly stated, a preferred embodiment of the invention is based on a scheme whereby reverse proxy configuration rules that are actually used are tracked, so that other rules can be removed, thereby improving performance.

### BRIEF DESCRIPTION OF THE DRAWINGS

A reverse proxy system and method incorporating the present invention will now be described, by way of example only, with reference to the accompanying drawing(s), in which:

FIG. 1 shows a block schematic diagram illustrating an example of a computing environment using a reverse proxy mechanism according to an embodiment of the invention;

FIG. 2 shows a block schematic diagram illustrating in greater detail the reverse proxy mechanism of FIG. 1; and

FIG. 3 shows a block schematic diagram illustrating in greater detail the rule mechanism of FIG. 2.

### DETAILED DESCRIPTION OF THE INVENTION

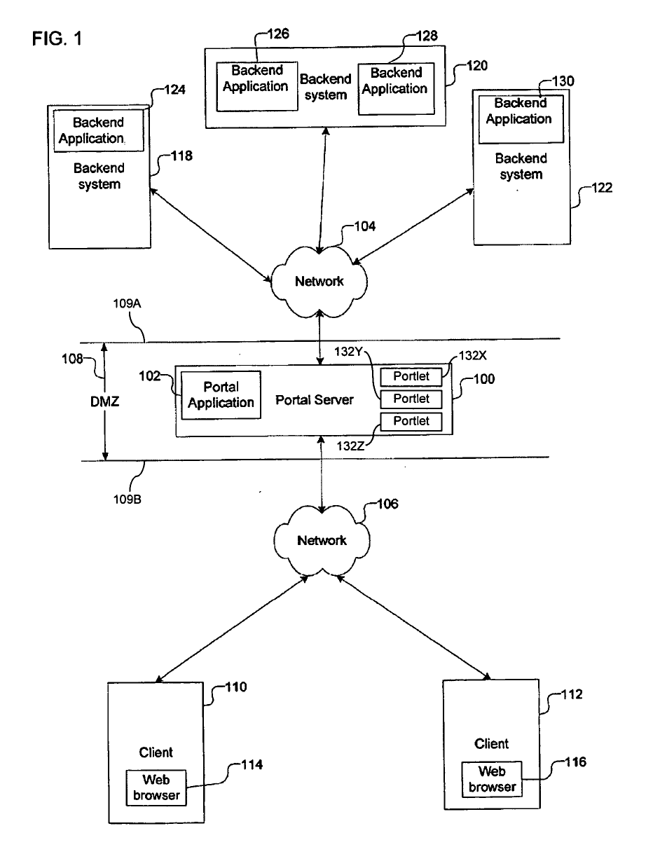

FIG. 1 illustrates a block diagram of a computing environment including an implementation of the invention. A portal server 100 comprises a portlet container 102, which manages a plurality of portlets 132X, 132Y, 132Z and connects networks 104 and 106. It should be understood that portal server 100, clients 110, 112, and application servers (backend systems) 118, 120, 122 comprise any type of device capable of accepting input, providing output, and communicating with another device. To this extent, portal server 100 represents any type of computerized system for providing access to a web site (e.g., a web server computer system), client systems 110, 112 represent any type of computerized system that can be used to access a computer network such as the World Wide Web (e.g., a mobile phone, a handheld computer, a personal digital assistant, a portable (laptop) computer, a desktop computer, a workstation, a mainframe computer etc.), and backend systems 118, 120, 122 represent any type of computerized system for providing data to other systems. Communications between client systems, application servers, portal server, and/or networks can occur via any combination of wire line and/or wireless transmission methods. As depicted in FIG. 1, network 104 is a local area network and network 106 is the Internet, however each could be another type of network, including, for example, Ethernet, wide area network (WAN), local area network (LAN), virtual private network (VPN), or other private network. For simplicity, only two client systems are shown, but it will be appreciated that any number of clients could connect to network 106.

Portal server 100 is located within a demilitarized zone (DMZ) 108. The DMZ allows the portal server 100 to host Internet services but at the same time prevents unauthorized access to the network 104 via Internet connections to the portal server 100. In addition to the use of firewalls 109A and 109B, extra security is provided by the use of one or more reverse proxy mechanisms which will be described below.

Backend systems 118, 120, 122 connect to portal server 100 via the LAN 104. Each of the backend systems 118, 120, 122 contains one or more backend application(s) 124, 126, 128, 130. As shown in FIG. 1, backend system 118 contains one backend application 124, backend system 120 contains two backend applications 126 and 128, and backend system 122 contains one backend application 130. The backend systems 118, 120, 122 may be any computational device such as a personal computer, a workstation, a server-class computer, a mainframe, a laptop, hand-held, palm-top or telephony device. The backend applications 124, 126, 128, 130 may be any server-based software application such as web-based electronic mail, an instant messenger application, a server-based spreadsheet, a database application, etc.

The portal server 100 may be, for example, a WebSphere® Portal Server (Registered Trade Mark of International Business Machines Corp. of Armonk, N.Y.), which arranges web content into a portal page containing one or more portlets. Each portlet includes a section of web content specified according to a user's preferences. For example, a user can establish his/her own portal page that has portlets for news, weather, sports, email etc. Several de-facto standards exist for writing portlets. Among these are WebSphere® Portal Server and the Java Specification Request (JSR)-168 Standard.

Clients 110 and 112 can connect to the portal server 100 through the network 106 via the hypertext transfer protocol (HTTP) from web browsers 114, 116. For example, web browser 114 may send a HTTP request to the portal server 100 across the Internet 106. When the request is received by the portal server 100, it determines if the request contains an action targeted to any of the portlets associated with the portal page and creates a list of portlets that need to be executed to satisfy the request. The portal server 100 requests the portlet container 102 to invoke the portlets to process the action. At least one portlet processes the action, and each invoked portlet generates a content fragment to be included in the new portal page. The portal server aggregates the output of the portlets in the portal page and sends the portal page back to the client 110. The web browser 114 on the client 110 renders the web page for display to a user.

The portlet container 102 receives content from each portlet 132X, 132Y, 132Z and hands the content to the portal server 100. The portal server 100 packages each portlet content fragment in a portlet window, adding a title and control buttons, and then aggregates the portlet windows into a complete portal page for rendering by a web browser on the client 110 or 112.

Portlets known as “concrete” portlets can have multiple instances. That is, the same concrete portlet can be used in many places (e.g., by different users), providing shared configuration. Additionally, a portlet developer can use portal administration tools to produce multiple copies of a portlet and then modify the configuration of each portlet to provide multiple concrete portlets, each with a different configuration. This allows configuration on a “per concrete portlet” basis to enable reverse proxying of different applications having different configuration requirements. Changes can be made to the configuration of one concrete portlet, without affecting the configuration of (and thus handling of a particular application by) another concrete portlet.

In the table below there are shown two concrete portlets each with a unique set of configuration rules, as well as a number of instances of each concrete portlet, whereby portlet instances 1a and 1b share a configuration, Configuration 1, and portlet instances 2a, 2b and 2c share Configuration 2.

| | | |
|---|---|---|
| Concrete portlet 1 | Configuration 1 | Portlet instance 1a |
| | | Portlet instance 1b |
| Concrete portlet 2 | Configuration 2 | Portlet instance 2a |
| | | Portlet instance 2b |
| | | Portlet instance 2c |

A portlet's different instances can be selected by a user for display using the added control buttons. Additionally, the portlet has a number of different modes which can be selected. Some of these modes are available only to a portlet developer or system administrator.

The normal mode of operation of a portlet is the View mode, which is how the portlet is usually initially displayed to a user. A portlet may also support a Help mode, which may provide a help page to enable users to obtain more information about the portlet, and an Edit mode, which lets a user customize and change the content of the portlet. In the Configuration mode of the portlet, a portal developer or administrator can alter the configuration rules of the portlet.

Client requests are usually triggered by URLs created by the portlets and called portlet URLs. A portlet URL is targeted to a particular portlet. There are two types of portlet URLs—action URLs and render URLs. Normally, a client request triggered by an action URL translates into one action request for the targeted portlet followed by many render requests—one per portlet in the portal page. A client request triggered by a render URL translates into many render requests—one per portlet in the page. Typically, in response to an action request a portlet updates its state based on the information sent in the action request parameters. The portlet may change its mode or window state, or instruct the portal server to redirect the user to a specific URL, for example. During a render request portlets generate content based on their current sate.

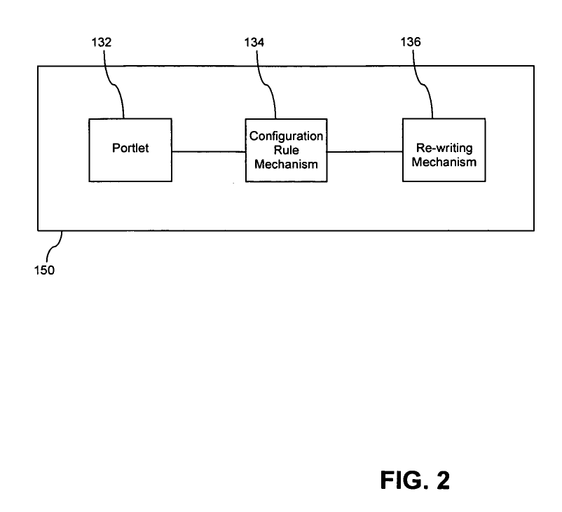

Referring now also to FIG. 2, one or more of the portlets 132X, 132Y, 132Z may be used in a reverse proxy mechanism 150 which will be explained below. The portal server 110 and reverse proxy mechanism 150 may be implemented in any programming language such as Java™ , C++, etc. The web pages sent by the portal server 100 to the clients 110 and 112, and the requests and responses sent to and received from the backend web applications, may include code in Active Server Pages (ASP), Java™ server pages, HyperText Markup languages (HTML), Extensible Markup Language (XML), etc.

The functional components of a reverse proxy mechanism 150 according to a preferred embodiment of the invention will now be described. For ease of reference some components of the system have been omitted. The reverse proxy mechanism 150 comprises a portlet 132 for producing content fragments for one or more portlet instances, a set of configuration rules in a configuration rule mechanism 134, and a rewriting mechanism 136.

The portlet 120 forwards requests to the rewriting mechanism 136 and forwards responses from the backend application (received via the rewriting mechanism 136) to the portal server 100 for aggregation into a portal window and portal page.

The rewriting mechanism 136 may, for example, be a J2EE servlet (i.e. Java 2 Enterprise Edition, Trade Mark of Sun Microsystems Inc) invoked by the portlet 132 and which comprises the code for carrying out the reverse proxy transformation of messages in dependence on the configuration rules, sharing this code with the portlet 120 when necessary. The rewriting mechanism 136 searches through the whole text of a response received from a backend application for any character string which corresponds correctly with any of the regular expression patterns listed in the configuration rules. If a character string corresponds correctly to one of the regular expression patterns in the configuration rules it can be said that there is a “match,” and the rewriting mechanism 136 applies the corresponding “Output Model” from the rule containing the regular expression, and which defines how the matching character string is to be rewritten.

As it is generally known, in computer programming, a “regular expression” is a formal expression of a string pattern which can be searched for and processed by a pattern-matching program. The method of determining which patterns should be rewritten used by the disclosed rewriting mechanism 136 may be based on regular expression pattern matching, in which certain characters, such as “.”, ” and “?”, for example, may be used to represent wild card characters or wild card character strings. Alternatively, any other specific technique for specifying patterns to be rewritten may be used, including pattern lists, or other techniques. The disclosed system may be embodied using a regular expression processing software package. One such regular expression package is provided through The Apache Jakarta Project, and described on the web at http://jakarta.apache.org/regexp.

The configuration rules of the reverse proxy mechanism 150 are defined to rewrite URLs contained within the intercepted content in order to ensure that subsequent requests are directed to the portal as opposed to the backend server. In addition, the rules may affect other elements of the intercepted content for example to ensure that URLs or scripted functions do not take the user's browser outside the context of the portlet. Thus, the disclosed rules can be used to manipulate and maintain a particular user interface. For example, code which instructs a browser to render text at the top of a web page may be rewritten to instruct the browser to render the text at the top of a portlet window on the page, so that the text remains within a user's view of a particular portlet, rather than taking over the whole page.

Examples of some configuration rules of the portlet include rules to transform HREF links, codebase links, action links and browser side redirection URLs. Additionally the rules can specify the transformation of applet parameter values. Applets often include parameters which indicate a server on which an image which the applet displays can be found. The rules can manipulate these to ensure that these do not refer to the backend web server.

Reverse proxying techniques such as described above are implemented in many known server-based products, in order to rewrite links on outgoing HTML, to make sure that they point back to the server doing the reverse proxying rather than the original destination). For example—
IBM®'s Websphere® Edge Server, optionally, allows a user to detect outgoing links to the “real server” so they can be rewritten to point to the Edge server instead.
IBM®'s Websphere® Clipper always looks through HTML to allow for link modification similar to the preceding example, but to redirect them to a portlet.
IBM®'s Domino Application Portlet functions similarly to the preceding example except that it supports a number of rules that allow the “tailoring” of this reverse proxy. It also comes with rules designed for Domino-specific reverse proxying.

It will be noted that in each of these examples it is necessary to parse and modify the outgoing HTML. Reverse proxying code typically relies on a hardwired set of rules as described above that handle most cases (especially in the case of Edge Server, where it is desirable not to use this feature at all—for performance reasons). In the case of the Domino Application Portlet however, there is considerable tailoring available though the use of either Jakarta Regular Expression Rules or HTML Parser Rules. The Domino Application Portlet provides out of the box, a set of tested rules for handling most standard Domino templates, and common extensions. In order to do so, the list of rules is quite considerable. As the processing time required is proportional to the number of rules, this means there is a considerable processing overhead.

If the number of rules is reduced to those actually needed for a given application, then performance can be improved accordingly. However, the rules in question are quite complex. It is very difficult to determine which rules are actually required without being familiar with the rule rewriting mechanism, and even if a portlet administrator has such familiarity, it requires a significant analysis, with a probable certain amount of error.

It is possible to combine all of the rules used by the Domino Application portlet into a single regular expression. However, in the Domino Application Portlet each rule is actually applied separately so that the output functions can be controlled individually. This aspect of the Domino Application Portlet usage of rewriting rules means that the usage of each rule can be tracked, e.g., according to:
If used
Date last used
Usage Count

As will be explained in greater detail below, in this exemplary embodiment of the present invention this information is used (e.g., autonomously or by a portlet administrator) to ensure that only the relevant rules are actually applied, thus speeding up the reverse proxying process.

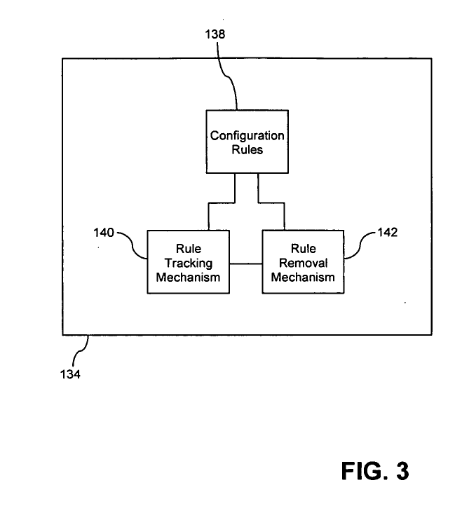

Referring now also to FIG. 3, in order to implement this, the rule mechanism 134 is expanded to include a set of rules 138, a rule tracking mechanism 140, and a rule removal mechanism 142, and the following scheme is applied:
Rule definitions are expanded to store all of the relevant tracking information in the rule tracking mechanism 140.
Rule processing updates this information on every use (i.e., the rule processing determines if a rule initiated part of the transformation—all rules will always be used until removed).
This information is made available to a portlet administrator who can choose to (using a rule removal mechanism 142):
   Remove all rules identified as not having been used;
   Remove all rules identified as not having been used since a particular date; or
   Remove all rules identified as having been used less than a predetermined number, N, of times.
This information can also be used to autonomically to improve portlet performance by either automatically removing rules, or reporting a likely appropriate removal to the portlet administrator. Thus, to do this the portlet administrator can select one of the following options:
   Remove/report any rule not used in a predetermined number, M, of previous days; or
   Remove/report any rule not used in a predetermined number, L, of total previous application hits.

It will thus be understood that this scheme adds automatic or selective performance configuration to the known rule based reverse-proxying concept. It will be appreciated that no knowledge of rule writing is required in order to apply this additional performance configuration.

It will be appreciated that the novel scheme described above is carried out in software running on a processor in one or more computers, and that the software may be provided as a computer program element carried on any suitable data carrier (not shown) such as a magnetic or optical computer disc.

It will be understood that other implementations may be utilized and structural and operational changes may be made without departing from the scope of the invention. For example, it will be appreciated that although the above example has been described in the context of rule removal (dependent on tracked rule usage) to improve the performance of subsequent rule processing, other forms of rule “tailoring” such as simplification (or other non-removal modification such as “mark as not to be processed further”), could alternatively be used.

1. A reverse proxy system for proxying, on a portal server, one or more web applications running on a web server, in response to a request for web content from a client computer system, the reverse proxy system comprising:
a portlet;
a set of configuration rules;
a rewriting mechanism configured to:
forward data, relating to a client request for Web content, to a Web application on the Web server;
receive a response from the Web application; and
rewrite the received response in accordance with the configuration rules;
tracking means for tracking usage of the set of configuration rules, and tailoring means, dependent on the tracking means, for tailoring at least one of the configuration rules for further processing.

2. The reverse proxy system of claim 1, wherein the tailoring means comprises means for removing at least one of the configuration rules from further processing.

3. The reverse proxy system of claim 1, wherein the tailoring means is arranged to tailor autonomously at least one of the configuration rules for further processing.

4. The reverse proxy system of claim 1, wherein the tailoring means is arranged to tailor under administrator control at least one of the configuration rules for further processing.

5. The reverse proxy system of claim 1, wherein the tracking means is arranged to track at least one of: if a rule has been used; when a rule was last used; and a count of a rule's usage.

6. The reverse proxy system of claim 1, wherein the tracking means is arranged to identify at least one of: a rule that has not been used; a rule that has not been used since a predetermined date; a rule that has been used less than a predetermined number of times; and a rule that has not been used in a predetermined number of total previous application hits.

7. The reverse proxy system of claim 1, wherein the portlet comprises a Domino Application portlet.

8. A reverse proxy method for proxying, on a portal server, one or more web applications running on a web server, in response to a request for web content from a client computer system, the reverse proxy method comprising:
providing a portlet;
providing a set of configuration rules;
in a rewriting mechanism:
forwarding data, relating to a client request for web content, to a web application on the Web server;
receiving a response from the Web application; and
rewriting the received response in accordance with the configuration rules;
tracking usage of the set of configuration rules, and tailoring, dependent on the tracked usage, at least one of the configuration rules for further processing.

9. The reverse proxy method of claim 8, wherein the step of tailoring comprises removing at least one of the configuration rules from further processing.

10. The reverse proxy method of claim 8, wherein the step of tailoring comprises tailoring autonomously at least one of the configuration rules for further processing.

11. The reverse proxy system of claim 8, wherein the step of tailoring comprises tailoring under administrator control at least one of the configuration rules for further processing.

12. The reverse proxy method of claim 8, wherein the step of tracking comprises at least one of: tracking if a rule has been used; tracking when a rule was last used; and tracking a count of a rule's usage.

13. The reverse proxy method of claim 8, wherein the step of tracking comprises at least one of: identifying a rule that has not been used; identifying a rule that has not been used since a predetermined date; identifying a rule that has been used less than a predetermined number of times; and identifying a rule that has not been used in a predetermined number of total previous application hits.

14. A computer program element stored on a data carrier and comprising computer program means for instructing the computer to perform substantially the method of claim 8.
